(19) United States
(12) Patent Application Publication
(10) Pub. No.: US 2006/0103972 A1
(43) Pub. Date: May 18, 2006

(54) Flexible data TPI in hard disk drives

(75) Inventors: Sang Hoon Chu, Santa Clara, CA (US); Kang Seok Lee, San Jose, CA (US); Keung Youn Cho, San Jose, CA (US); Jong Yoon Kim, San Jose, CA (US); Jung Ho Lee, San Jose, CA (US); Cheol Hoon Park, Suwon (KR); Hae Jung Lee, Santa Clara, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd.

(21) Appl. No.: 10/986,684

(22) Filed: Nov. 12, 2004

(51) Int. Cl. G11B 5/596

(52) U.S. Cl. 360/78.04

(57) ABSTRACT

A hard disk drive with a disk that has a plurality of servo sections and a plurality of data sections. At least some of the data sections have a track density different than the track density of the servo sections. The disk drive has a controller that may convert a data track number to a servo track number to compensate for the different densities. The conversion may be required to conduct a seek routine to access a data track associated with the data track number.

### BACKGROUND OF THE INVENTION

1. Field of the Invention

The present invention relates to a hard disk drive.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGA's are suspended from an actuator arm. The actuator arm has a voice coil motor that can move the heads across the surfaces of the disks.

Information is typically stored on radial tracks that extend across the surface of each disk. Each track is typically divided into a number of segments or sectors. Each sector may include, among other things, a servo section and a data section. The servo sections are used to align the heads with the center of a track. The voice coil motor and actuator arm can move the heads to different tracks of the disks to access different data sectors. The voice coil motor is energized in accordance with signals from control circuits. The process of moving the heads from track to track is commonly referred to as a seek routine.

During the initial assembly of a disk drive the servo sections are written onto the disk(s). Servo is typically written onto the disk(s) by a servo writer. The servo writer writes servo in accordance with a predetermined track density. For example, the writer may write servo at 10,000 tracks per inch (“TPI”). The resultant disk will have servo sections at a density of 10,000 sections per inch measured across the radius of the disk(s).

It may be desirable to have a data track density that is different than the radial density of the servo sections. For example, because of head skew it may be desirable to have a data track density that is lower at the inner and outer diameter areas of the disk(s). It may be determined that the heads assembled in the disk optimally operate at track densities different from the track density of the servo sections. It would be desirable to have a disk drive that has a servo track density different from a data track density.

### BRIEF SUMMARY OF THE INVENTION

A hard disk drive having a disk that has a plurality of servo sections and a plurality of data sections. At least a portion of said data sections having a track density different than a track density of the servo sections.

### BRIEF DESCRIPTION OF THE DRAWINGS

FIG. 1 is a top view of an embodiment of a hard disk drive;

FIG. 2 is a schematic of an electrical circuit for the hard disk drive;

FIG. 3 is an illustration of a track of a disk;

FIG. 4 is a graph showing a profile of servo track numbers versus data track numbers;

FIG. 5 is a graph showing a servo track number/data track number profiles for different heads of the drive; and, FIG. 6 is a flowchart for a seek routine of the hard disk drive.

### DETAILED DESCRIPTION

Disclosed is a hard disk drive with a disk that has a plurality of servo sections and a plurality of data sections. At least some of the data sections have a track density different than the track density of the servo sections. The disk drive has a controller that may convert a data track number to a servo track number to compensate for the different densities. The conversion may be required to conduct a seek routine to access a data track associated with the data track number.

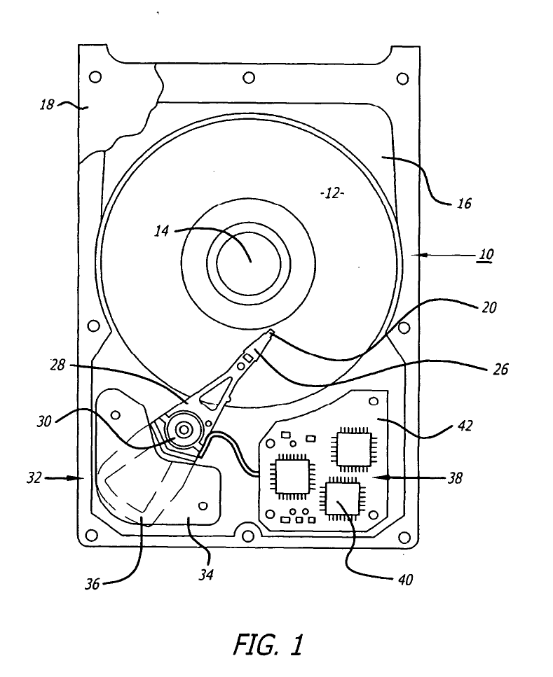

Referring to the drawings more particularly by reference numbers, FIG. 1 shows an embodiment of a hard disk drive 10 of the present invention. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. Each head 20 may have separate write (not shown) and read elements (not shown). The heads 20 are gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

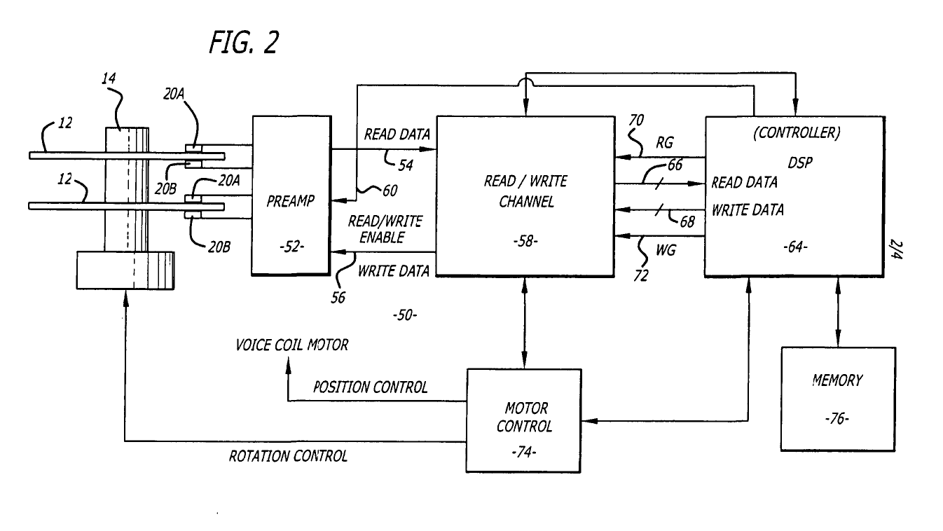

FIG. 2 shows an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 58 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a software routine, including a routine(s) to write and read data from the disks 12. The read/write channel circuit 58 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”).

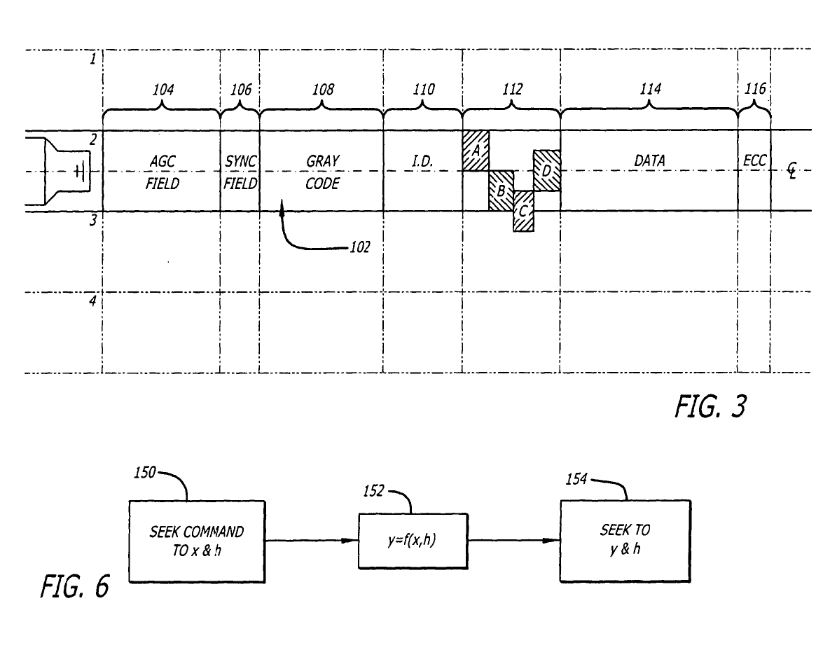

As shown in FIG. 3, each disk surface has a plurality of tracks 100. Each track 100 is divided into a number of sectors 102. Each sector 102 may have an automatic gain control (“AGC”) field 104 used to control the level of the signal read by the heads 20 and a sync field 106 used to sync the read signal. The sector 102 may contain a GRAY code field 108 and an I.D. field 110. The GRAY field 108 contains ID information that identifies the track. For example, the GRAY field may contain the track number. The I.D field 110 identifies the specific sector within the track 100. The sector 102 includes a servo field 112 and a data field 114. The servo field 112 typically contains a number of servo bits A, B, C and D that are used to center the head 20 onto the data field 114. The sector 102 may also include an error correction code field 116 used to detect and correct errors in the data. The servo and data fields will also be referred to as servo and data sections, respectively. Although an embedded servo scheme is shown, it is to be understood that the servo bits may be located on a dedicated disk surface in a dedicated servo scheme.

Each track is assigned a number that is used to access the track. The controller 64 determines which track should be accessed for reading and/or writing data. For example, the heads may be located at track number 2000. The controller 64 may determine that data is to be written at track 2050. The controller 64 provides a command(s) to excite the voice coil motor and move the heads to track 2050.

The servo sections 112 may have a track density along a radial direction of a disk surface. The data sections 114 may also have a track density measured along a radial direction. The track density of the data sections may be different from the track density of the servo sections 112. To account for the different densities the controller 64 converts the data track numbers to servo track numbers. The conversion may be performed in accordance with the following equation:
Y=f(x,h) (1)
Where;

y=the servo track number.

f=the conversion function.

x=the data track number.

h=the head track number.

By way of example, the disk may be segmented into three different regions, outer diameter (“OD”), middle diameter (“MD”) and inner diameter (“ID”). A servo writer may write the servo sections at a track density of 10,000 tracks per inch (“TPI”). The data sections in the OD region may have a track density of 5000 TPI. The MD region may have a data track density of 10,000 TPI, and the ID region may have a data track density of 7500 TPI. It may be desirable to have such variable track densities to compensate for different drive performances in the OD and ID of the disks. The conversion function may be the following piecewise linear function:

$$f ( x , h ) = \{ \begin{matrix}2 x , & if & x \leq 3000 \\ x + 3000 , & if & 3000 < x \leq 7000 \\ 4 / 3 ( x - 7000 ) + 10000 , & if & x > 7000\end{matrix} \} \qquad ( 2 )$$

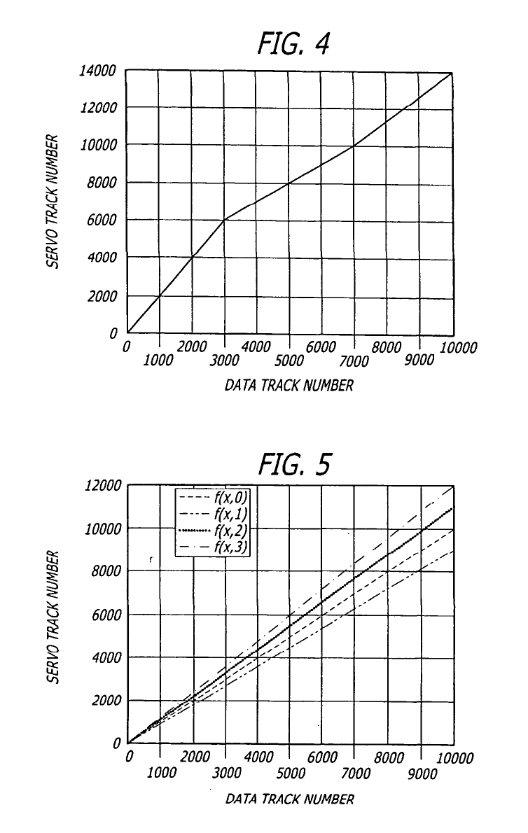

By way of example, with such a function the controller will convert data track number 2000 to servo track number 4000, or track number 4000 to 7000. The conversion function (2) is depicted graphically in FIG. 4.

Due to the different characteristics of each head it may be desirable to vary the data track density per head. For example, assuming a 4 head drive and a servo track density of 10,000 TPI, the first head may have a data track density of 10,000, the second head a data track density of 9000 TPI, a third head with a data track density of 11,000 TPI and a fourth head having a data track density of 12,000 TPI. The conversion function may have the following form:

$$f ( x , h ) = \{ \begin{matrix}x , & if & h = 0 \\ .9 x , & if & h = 1 \\ 1.1 x , & if & h = 2 \\ 1.2 x & if & h = 3\end{matrix} \} \qquad ( 3 )$$

The function is graphically depicted in FIG. 5.

Referring to FIG. 6, in operation, a read or write operation is required of data track x in logic block 150. In block 152, the controller 64 converts the data track number x to a servo track number y in accordance with the conversion function. In block 154 the heads are moved to the servo track that correlates to the servo track number y in accordance with a seek routine.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A hard disk drive, comprising:
a disk that has a plurality of servo tracks at a servo track density, and a plurality of data tracks, at least some of said data tracks having a data track density different than said servo track density;
a spindle motor that rotates said disk;
a plurality of heads coupled to said disk including a first head and a second head;
an actuator arm coupled to said heads;
a voice coil motor coupled to said actuator arm; and, a controller coupled to said heads said controller converts a data track number to a servo track number in accordance with a conversion function that varies as a function of a head number, said first head having a first servo track number that is different than a second servo track number of said second head.

2. (canceled)

3. (canceled)

4. The disk drive of claim 1, wherein said conversion function is a linear function.

5. The disk drive of claim 1, wherein said conversion function varies as a function of an area of said disk.

6. (canceled)

7. (canceled)

8. (canceled)

9. (canceled)

10. (canceled)

11. (canceled)

12. A hard disk drive, comprising:
a disk that has a plurality of servo tracks at a servo track density, and a plurality of data tracks, at least some of said data tracks having a data track density different that said servo track density, said servo tracks having a plurality of servo track numbers and said data tracks having a plurality of data track numbers;
a spindle motor that rotates said disk;
a plurality of heads coupled to said disk including a first head and a second head;
an actuator arm coupled to said heads means;
a voice coil motor coupled to said actuator arm; and,
conversion means for converting one of the data track numbers to one of the servo track numbers to move said heads and access a data track in accordance with a conversion function that varies as a function of a head number, said first head having a first servo track number that is different than a second servo track number of said second head.

13. (canceled)

14. The disk drive of claim 12, wherein said conversion function is a linear function.

15. The disk drive of claim 12, wherein said conversion function varies as a function of an area of said disk.

16. (canceled)

17. A method for reading data on a disk of a hard disk drive that has a first head and a second head, comprising:
converting a data track number to a servo track number in accordance with a conversion function that is a function of a head number, the first head having a first servo track number that is different than a second servo track number of the second head;
moving the first head to a servo track having the first servo track number and the second head to a servo track having the second servo track number; and,
reading data in a data track that corresponds to the servo track numbers.

18. (canceled)

19. The method of claim 17, wherein said conversion function is a linear function.

20. The method of claim 17, wherein said conversion function varies as a function of an area of said disk.

21. (canceled)
